(19) United States
(12) Patent Application Publication
(10) Pub. No.: US 2021/0110161 A1
(43) Pub. Date: Apr. 15, 2021

(54) INTERACTIVE TRY-ON SYSTEM AND METHOD FOR EYEGLASS FRAME

(71) Applicant: Fitglasses Ltd, Taipei (TW)

(72) Inventor: Hung-Chih Wang, New Taipei (TW)

(21) Appl. No.: 17/029,289

(22) Filed: Sep. 23, 2020

(30) Foreign Application Priority Data
Oct. 15, 2019 (TW) 108136970

(51) Int. Cl. G06K 9/00; H04L 29/08; H04N 5/232; G06Q 30/06; G06Q 30/02; G06F 16/958; G06F 16/955; G02C 7/02

(52) U.S. Cl. CPC G06K 9/00671; H04L 67/36; H04N 5/23219; G06K 9/00248; G02C 7/027; G06Q 30/0277; G06Q 30/0631; G06F 16/958; G06F 16/955; G06Q 30/0643

(57) ABSTRACT

An interactive try-on system and method for eyeglass frame, which utilizes an augmented reality module to combine an image of the consumer itself with images of various eyeglass frames. The consumer can directly see the eyeglass frame on the display device, and decide which eyeglass frame to buy, and then inform the service staff the eyeglass frame that you want to buy, whereby consumers can try a variety of different eyeglass frames.

### CROSS REFERENCE TO RELATED APPLICATIONS

The present application claims the benefit of Taiwanese Patent Application No. 108136970 filed on Oct. 15, 2019, the contents of which are incorporated herein by reference in their entirety.

### BACKGROUND OF THE INVENTION

### 1. Field of the Invention

The present invention relates to a try-on system and method for an eyeglass frame, and more particularly to an interactive try-on system and method for an eyeglass frame, which utilizes augmented reality to combine a portrait with images of different eyeglass frames.

### 2. Description of the Related Art

With the progress of society, people spent more and more time for reading books and watching movies and TV shows. The population of myopia and astigmatism is thus increased. In addition, with the increase of age, the population with presbyopia also accounts for a considerable proportion. Therefore, the eyeglasses needed for vision correction have gradually become a necessity of life. Since the eyeglasses are worn on the face, in addition to the comfort of the eyeglasses, the aesthetic design of the eyeglasses and matching with the facial contours, even with the wear, become part of the wearing style.

The traditional eyeglasses store generally displays a variety of eyeglass frames in show windows and provides mirrors. The consumer first selects one of the eyeglass frames placed in the show window and informs the service staff of the selected eyeglass frame, the service staff takes out the selected eyeglass frame from the show window for the consumer, the consumer wears the eyeglass frame in front of the mirror to determine whether the eyeglass frame matches with the overall appearance of the face and the wearing style by watching the image reflected by the mirror and to feel the comfort of the eyeglass frame.

However, the try-on method for eyeglass frames in the foregoing traditional eyeglasses store requires a service staff to taken out the eyeglass frames one by one from the show window, and the consumer tries on the eyeglass frames one by one in front of the mirror. This process is rather cumbersome. In such a cumbersome process, the interest in shopping of the consumers is gradually reduced, and the consumers must physically try on the eyeglass frames to experience the comfort.

### SUMMARY OF THE INVENTION

In view of the above, an objective of the present invention is to provide an interactive try-on system and method for an eyeglass frame, which utilizes an augmented reality module to combine an image of the consumer itself with images of various eyeglass frames. The consumer can directly see the combination of the image of the eyeglass frame and the portrait of the consumer on the display device, and decide which eyeglass frame to buy, and then inform the service staff the eyeglass frame that you want to buy, whereby consumers can try a variety of different eyeglass frames. Moreover, the interactive try-on system for eyeglass frame of the present invention can use a plurality of face capture lenses to capture features of various parts of the consumer's face and calculate the best eyeglass frame size for the consumer according to the features of each part. An eyeglass is selected according to the obtained eyeglass frame size, and the consumer's preference is obtained by determining the facial expression when the consumer tries on the eyeglass, thereby selecting one or more suitable eyeglass frames from the database and recommending it or them to the consumer.

An embodiment of the interactive try-on system for eyeglass frame of the present invention comprises an image interaction unit and a servo unit, and the servo unit in signal connection to the image interaction unit. The image interaction unit can interact with the consumer, while a remote servo unit provides operations and information required by the image interaction unit. The image interaction unit comprises an image capture device, a display device, and a host device. The image capture device comprises at least one lens configured to capture an image of a specific area and generate an image signal. The display device is configured to simultaneously display a plurality of frames. The host device is in signal connection to the image capture device and the display device and comprises an image receiving storage module and a webpage display module. The image receiving storage module is in signal connection to the image capture device and is configured to receive the image signal and store same to form image data. The webpage display module is in signal connection to the display device and is configured to transmit at least one piece of webpage data to the display device for display. The servo unit comprises a first servo device and a second servo device. The first servo device is in signal connection to the host device and comprises an image identification module and an augmented reality generation module. The image identification module is in signal connection to the image receiving storage module and is configured to receive the image data and identify same, and if the image data is identified to contain a portrait, then correspondingly generate a portrait object. The augmented reality generation module is in signal connection to the image identification unit and is configured to receive the portrait object and generate augmented reality webpage data. The augmented reality webpage data is transmitted to the webpage display module of the host device. The second servo device is in signal connection to the host device and the first servo device and comprises a display interface switching module, an eyeglass frame database module, and an eyeglass frame selection module. The display interface switching module is in signal connection to a data receiving transmission module of the host device and is configured to switch between a standby interface and a try-on interface. The eyeglass frame database module is in signal connection to the first server and is configured to store a plurality of eyeglass frame codes. The eyeglass frame selection module is in signal connection to the eyeglass frame database module and is configured to receive a selection signal and select an eyeglass frame code from the eyeglass frame database module according to the selection signal, wherein the first servo device transmits a control signal to the second servo device when the image identification module of the first servo device generates the portrait object, so that the display interface switching module switches from the standby interface to the try-on interface. The first server obtains the eyeglass frame code selected by the eyeglass frame selection module of the second server. The augmented reality generation module generates a corresponding eyeglass frame object according to the eyeglass frame code and adds the eyeglass frame object to the augmented reality webpage data and superimposes the eyeglass frame object on the portrait object.

An embodiment of the interactive try-on method for eyeglass frame of the present invention comprises the following steps: capturing an area image; identifying the area image; if it is identified that the area image contains an image, displaying an augmented reality frame and generating a portrait object, the augmented reality frame comprising the portrait object; selecting at least one eyeglass frame image from the plurality of eyeglass frame images, and correspondingly generating an eyeglass frame object; adding the eyeglass frame object to the augmented reality frame and superimposing to the portrait object; and storing the portrait object and the eyeglass frame object.

### BRIEF DESCRIPTION OF THE DRAWINGS

FIG. 1 is a system block diagram of an embodiment of an interactive try-on system for eyeglass frame of the present invention.

FIG. 2 is a picture presented by a display device when the interactive try-on system for eyeglass frame of FIG. 1 is in a standby mode.

FIG. 3 is a picture presented by the display device when the interactive try-on system for eyeglass frame of FIG. 1 is in a try-on mode.

FIG. 4 is a flowchart of an embodiment of an interactive try-on method for eyeglass frame of the present invention.

FIG. 5 is a schematic diagram of switching from a standby interface to a try-on interface in the interactive try-on method for eyeglass frame of the present invention.

FIG. 6a is a schematic diagram depicting that a consumer selects an eyeglass frame with a touch display in the interactive try-on method for eyeglass frame of the present invention.

FIG. 6b is a schematic diagram depicting that a consumer selecting an eyeglass frame with a mobile device in the interactive try-on method for eyeglass frame of the present invention.

FIG. 7a is a schematic diagram depicting that the consumer's behavior of selecting eyeglass frames is analyzed in the interactive try-on method for eyeglass frame of the present invention.

FIG. 7b is a schematic diagram depicting that statistics about eyeglass frames selected by the consumer are collected in the interactive try-on method for eyeglass frame of the present invention.

FIG. 8 is a system block diagram of another embodiment of an interactive try-on system for eyeglass frame of the present invention.

### DETAILED DESCRIPTION OF THE PREFERRED EMBODIMENTS

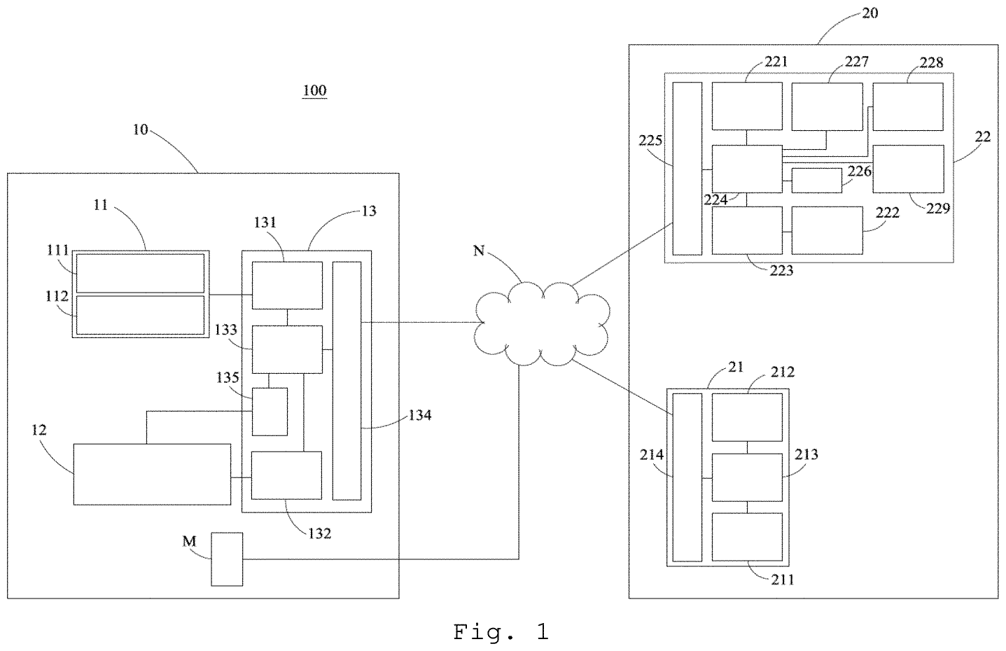

Referring to FIG. 1, an embodiment of an interactive try-on system for eyeglass frame of the present invention is illustrated. The interactive try-on system 100 for eyeglass frame of the present invention includes an image interaction unit 10 and a servo unit 20. The image interaction unit 10 has a function of displaying information to a consumer and accepting information input by the consumer, thereby enabling interaction with the consumer. Moreover, the servo unit 20 provides operations or data required by the image interaction unit 10 to display information. Description is made below respectively.

The image interaction unit 10 includes an image capture device 11, a display device 12, and a host device 13. The image capture device 11 and the display device 12 can be placed in, for example, a sales department of the eyewear company. The image capture device 11 includes an image capture lens 111. The image capture lens 111 can be fixedly oriented to an area in the space to continuously capture images of the area. The display device 12 can display a plurality of frames simultaneously. In this embodiment, in order to facilitate interaction with the consumer, the image capture lens 111 of the image capture device 11 can detect whether the consumer stays at an area in front of the display device 12, and thus the area can be an area in front of the display device 12, for example, an area inside the eyeglasses store where the consumer tries on eyeglass frames or an area outside the eyeglasses store such as a corridor. Moreover, the display device 12 can adopt a large-sized liquid crystal screen, for example, a liquid crystal screen of 42 inches or more. The display device 12 can be disposed vertically or horizontally, as needed. In this embodiment, the display device 12 is disposed vertically.

The host device 13 is in signal connection to the image capture device 11 and the display device 12. The host device 13 includes an image receiving storage module 131 and a webpage display module 132. The host device 13 further includes a host control module 133, a host data transceiver module 134, and a touch module 135. The image receiving storage module 131 is in signal connection to the image capture device 11. An image signal captured by the image capture device 11 is transmitted to the image receiving storage module 131 and can be stored in the image receiving storage module 131 as image data. The webpage display module 32 is in signal connection to the display device 12, and can receive at least one piece of webpage data, and generate a picture and then transmits the picture to the display device 12 for display. The image receiving storage module 131 and the webpage display module 132 are in signal connection to the host control module 133. The host control module 133 is in signal connection to the host data transceiver module 134. The image data in the image receiving storage module 131 is read by the host control module 133, and then transmitted by the host data transceiver module 134 to the outside. Moreover, the webpage data from an external server can also be received by the host data transceiver module 134, and then transmitted by the host control module 133 to the webpage display module 132. If the display device 12 is a touch display device, the touch module 135 can receive the selection signal from the display device 12. The selection signal can be generated by a sensing element of the display device 12 after the consumer presses an image of the eyeglass frame displayed by the display device 12, and then the selection signal is transmitted by the host control module 133 to the outside via the host data transceiver module 134.

The servo unit 20 includes a first servo device 21 and a second servo device 22. The first servo device 21 generates an augmented reality. The second servo device 22 provides data related to the eyeglass frames and can analyze facial features of the consumer to recommend the most suitable eyeglass frame.

The first servo device 21 is in signal connection to the host device 30. In this embodiment, the first servo device 21 is connected to the host device 30 via a network N. For example, the host device 30 stores the Uniform Resource Locator (URL) of the first servo device 21, and the host device 30 can receive the webpage data provided by the first servo device 21 by means of the URL of the first servo device 21. The first servo device 21 includes an image identification module 211 and an augmented reality generation module 212. The first servo device 21 further includes a first control module 213 and a first data transceiver module 214. The image identification module 211 and the augmented reality generation module 212 are in signal connection to the first control module 213, and the first control module 213 is in signal connection to the first data transceiver module 214.

The image identification module 211 is in signal connection to the image receiving storage module 131 of the host device 13. As described above, the image capture lens 111 of the image capture device 11 continuously captures the image of the specific area and transmits the captured images to the image receiving storage module 131 to be stored as image data. The image data is transmitted to the first servo device 21 via the network N and is received by the first data transceiver module 214 and then transmitted by the first control module 213 to the image identification module 211. The image identification module 211 identifies the image data. If the image data is identified to contain a portrait, a portrait object is generated correspondingly. The augmented reality generation module 212 receives the portrait object via the first control module 213 to generate augmented reality webpage data, and the augmented reality webpage data is transmitted to the webpage display module 132 of the host device 13. The webpage display module 132 displays the augmented reality webpage on the display device 12.

The second servo device 22 is in signal connection to the host device 13 and the first servo device 21. In this embodiment, the second servo device 22 is connected to the host device 13 and the first servo device 21 via the network N. The second servo device 22 includes a display interface switching module 221, an eyeglass frame database module 222, and an eyeglass frame selection module 223. The second servo device 22 further includes a second control module 224 and a second data transceiver module 225. The second control module 224 is in signal connection to the display interface switching module 221 and the eyeglass frame selection module 223, and the eyeglass frame selection module 223 is in signal connection to the eyeglass frame database module 222.

The display interface switching module 221 is in signal connection to the host control module 133 of the host device 13 and the image identification module 211 of the first servo device 21. If the image data is identified by the image identification module 211 to contain a portrait, the first control module 213 of the first servo device 21 sends a control signal to the display interface switching module 221 of the second servo device 22. In this case, if the interactive try-on system 100 for eyeglass frame is in a standby mode (the interface displayed by the display device 12 is a standby interface), the display interface switching module 221 switches the standby mode to a try-on mode, and the display device 12 displays the try-on interface. In addition, when the image data is identified by the image identification module 211 to contain no portrait, the first control module 213 of the first servo device 21 sends a control signal to the display interface switching module 221 of the second servo device 22, and the display interface switching module 221 switches the try-on mode back to the standby mode.

The eyeglass frame database module 222 stores a plurality of eyeglass frame codes. The eyeglass frame selection module 223 is in signal connection to the eyeglass frame database module 222 and is configured to receive a selection signal, such as the selection signal generated by pressing the display device 12 by the consumer. The eyeglass frame selection module 223 selects an eyeglass frame code from the eyeglass frame database module 222 according to the selection signal.

The second servo device 22 further includes an advertisement data supply module 226 and an eyeglass frame matching storage module 227.

The advertisement data supply module 226 and the eyeglass frame matching storage module 227 are both in signal connection to the second control module 224, and the advertisement data supply module 226 supplies the advertisement webpage data to the webpage display module 32 of the host device 13. The eyeglass frame matching storage module 227 is configured to store the code of the eyeglass frame selected by the consumer and the portrait of the consumer.

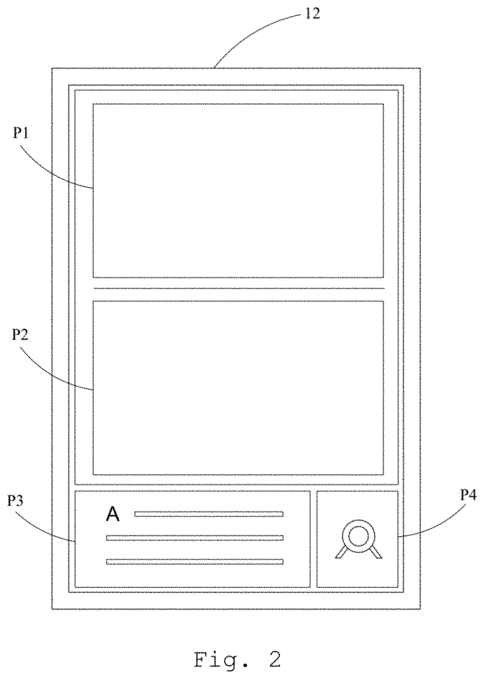

The display interface switching module 221 switches the interface to the standby interface when the interactive try-on system 100 for eyeglass frame is in the standby state. In this case, the standby interface displayed by the display device 12 is mainly the advertisement webpage. As shown in FIG. 2, a picture of the standby interface is illustrated, and frames P1 to P4 are included. The frame P1 can play an advertisement movie, which can be a streamed advertisement movie, and the frame P2 can be a plurality of advertisement images played in the form of a slide. The frame P3 can be the instruction for use of the interactive try-on system 100 for eyeglass frame of the present invention, and the frame of S4 normally displays an image of the area captured by the image capture lens 111 of the image capture device 11. The advertisement data supply module 226 provides the advertisement webpage data to the webpage display module 32 of the host device 13, and the webpage display module 32 converts the advertisement webpage data into the advertisement webpage frame to be played in the frame P1 or P2 of the display device 12. In another embodiment, the advertisement webpage frame can also cover the area of the frame P1 or P2.

When a consumer enters an area captured by the image capture lens 111 of the image capture device 11, the image capture lens 111 captures an image of the area and transmits an image signal to the image receiving storage module 131 to be stored as image data. The image data is transmitted to the image identification module 211 of the first servo device 21 for identification, and the image identification module 211 identifies that the image in the area contains a portrait, and then the first control module 213 sends a control signal to the display interface switching module 221 of the second servo device 22, the display interface switching module 221 switches from the standby interface to the try-on interface, and generates a portrait object according to the identified image, and merges the portrait object into the augmented reality.

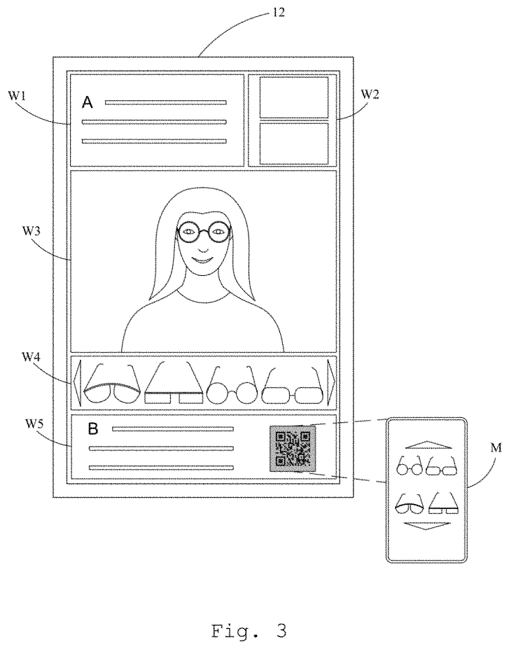

The picture displayed by the try-on interface on the display device 12 is as shown in FIG. 3, wherein the frame W1 is the instruction for use of the interactive try-on system 100 for eyeglass frame of the present invention, the frame W2 plays an advertisement webpage or a movie, and the frame W3 plays the augmented reality webpage. The frame W3 can embed the augmented reality webpage frame into the picture with i-frame. The frame W4 plays webpages of browsing and selecting the eyeglass frames, and the frame W5 displays an operation instruction for switching the eyeglass frame and a quick response code (QR code) that can be recognized by the mobile device, and the QR code corresponds to the URL of the first server 21.

Therefore, the consumer can see his or her image on the augmented reality webpage, and in the case where the display device 12 is a touch display device, the eyeglass frame that the consumer wants to try on can be selected in the frame W4 by means of a selection device which can exemplarily a touch assembly of the touch display device, such as a touch panel. After the eyeglass frame that the consumer wants to try on is selected, the selection signal is transmitted from the touch module 135 to the second servo device 22. The eyeglass frame selection module 223 of the second servo device 22 reads the corresponding eyeglass frame code from the eyeglass frame database module 222 according to the selection signal and transmits it to the augmented reality generation module 212 of the first server 21. The augmented reality generation module 212 integrates an image of the selected eyeglass frame into the augmented reality webpage and superimposes the image on the portrait object. In this way, the consumer can see an image in which his head image wears the selected eyeglass frame from the frame W3.

In another embodiment, the mobile device M is connected to the augmented reality generation module 212 of the first servo device 21 by reading the QR code in the frame W5. Images of a plurality of eyeglass frames are displayed on the touch screen of the mobile device M. After the consumer selects the eyeglass frame that he/she wants to try on, the mobile device M transmits the selection signal to the second servo device 22 via the network N, and the eyeglass frame selection module 223 reads the corresponding eyeglass frame code from the eyeglass frame database module 222 according to the selection signal.

After the eyeglass frame selection module 223 reads the eyeglass frame code from the eyeglass frame database module 222, the eyeglass frame code can be stored in a temporary memory module, and the augmented reality generation module 212 of the first server 21 sends a request for the eyeglass frame code to the second server 22 at a predetermined interval. For example, the augmented reality generation module 21 sends a request for the eyeglass frame code every two seconds, and the second server 22 transmits the eyeglass frame code in the temporary memory module to the augmented reality generation module 212 of the first server 21 after receiving the request, so as to generate a picture in which the corresponding eyeglass frame is superimposed on the portrait. When the consumer selects another eyeglass frame, the eyeglass frame selection module 223 reads a corresponding eyeglass frame code from the eyeglass frame database module 222 and stores same in the temporary memory module to replace the previous eyeglass frame code. In this way, the augmented reality generation module 212 determines whether the eyeglass frame code is changed when the augmented reality generation module 212 of the first server 21 sends a request to the second server 22 for the current eyeglass frame code. If the eyeglass frame code is changed, the augmented reality generation module 212 adds the corresponding eyeglass frame object to the augmented reality according to the obtained eyeglass frame code, and the consumer can see on the frame W3 that the selected eyeglass frame is superimposed on his/her own portrait.

When the consumer leaves the area in front of the display device 12, that is, when the consumer leaves the area of the image captured by the image capture lens 111 of the image capture device 11, the image capture lens 111 captures the image of the area and transmits to the image identification module 211 of the first servo device 21, the image identification module 211 identifies the image and determines whether the image contains an image, the first control module 213 sends a control signal to the display interface switching module 221 of the second servo device 22, the display interface switching module 221 switches the try-on interface back to the standby interface, and the picture displayed by display device 12 is switched from the picture shown in FIG. 3 back to the picture shown in FIG. 2.

In addition that the consumer selects the eyeglass frame that he/she wants to try on from the display device 12 or the mobile device M, and the result is displayed on the display device 12, the interactive try-on system 100 for eyeglass frame of the present invention can also recommend appropriate eyeglass frames to the consumer according to the consumer's face shape and preferences, and the related devices and functions are detailed below.

The image capture device 11 further includes a plurality of face capture lenses 112, and the face capture lenses 112 are in signal connection to the image receiving storage module 131. The face capture lenses 112 are arranged to capture features of a face from different angles.

In this embodiment, the face capture lenses 112 are arranged in a circular arc. For example, the face capture lenses 112 are arranged on the plastic frame or the iron frame such that the face capture lenses 112 are about 15 cm away from the consumer and arranged in a half circle from the left ear of the consumer to the right ear. Images of different parts of the face are captured by means of the plurality of face capture lenses 112 from different angles to obtain a plurality of pieces of face image data.

In addition, the first control module 213 sends a control signal to the host control module 133 of the host device 13, after the face capture lens 112 determines that the area image captured by the image capture lens 111 contains an image according to the identification result of the image identification module 211 of the first server 21, the host control module 133 actuates the face capture lens 112, and the plurality of the face images captured by the face capture lens 112 are transmitted to the image receiving storage module 131.

The second servo device 22 further includes a facial feature measurement module 228 and a data analysis module 229. The facial feature measurement module 228 and the data analysis module 229 are in signal connection to the second control module 224.

Most of the face images are transmitted from the image receiving storage module 131 to the facial feature measurement module 228. The facial feature measurement module 228 can obtain a three-dimensional image of the consumer's face through the images captured by the face capture lenses 112 and obtain the size of each part of the consumer's face. The size of each part of the consumer's face is transmitted to the data analysis module 229, and then the data analysis module 229 can obtain an eyeglass frame size suitable for the consumer via an appropriate calculation formula, e.g., the correlation formulas of the eyeglass frame size and the facial feature size disclosed in the Taiwan Patent Application No. 106118167, which is proposed by the inventor of the present invention:
a formula for calculating the width of the eyeglass frame:

P=−1.036X²+23.365X−2.089Y+Z±5
wherein P is the eyeglass frame width (mm), X is the user's nose bridge height (mm), Y is the user's nose bridge width (mm), and Z is the distance between the user's eye and ear (mm);
a formula for calculating the angle of a nose pad:

M=180−Q=180−Tan⁻¹(X/(Y/2))
wherein M represents the nose pad angle (°), Y represents the nose bridge width (mm), X represents the nose bridge height (mm), and Q represents the nose bridge inclination (°); and
a formula for calculating the temple length of the eyeglass frame:

R=Z+13+F
wherein Z represents the eye to ear distance (mm), R represents the temple length (mm), and F represents the upper and lower limit (mm), generally ranging from 0 to 40 mm.

After the data analysis module 229 calculates the optimal eyeglass frame size, the eyeglass frame selection module 223 selects one or more eyeglass frames suitable for the consumer from the eyeglass frame database module 222 according to the calculated eyeglass frame size and displays same on the display device 12 or the mobile device M of the consumer to recommend the consumer to make a selection. After the consumer selects an eyeglass frame, the eyeglass frame selection module 223 transmits the selected eyeglass frame code to the augmented reality generation module 212 of the first server 21 and integrates the corresponding eyeglass frame object into the augmented reality picture.

In addition, the display device 12 can also be provided with a loudspeaker. When a consumer enters the area in front of the display device 12, and the image captured by the image capture lens 111 of the capture device 11 is identified to contain an image, a voice guidance is provided by the host device 13 and is emitted from the loudspeaker of the display device 12 to attract the consumer's attention to approach the display device 12, and the consumer is guided to a specific position by means of the voice guidance, so that the face capture lens 112 can accurately capture the image of each part of the consumer's face.

In addition, in another embodiment, a start button can also be disposed beside the display device 12, or a start image is directly disposed on the display device 12 (the touch display). The display device 12 still displays the standby interface when the consumer enters the area in front of the display device 12, and the display device 12 is not switched to the try-on interface until the consumer presses the start button or touches the start image.

Since the interactive try-on system 100 for eyeglass frame of the present invention has a plurality of face capture lenses 112 which capture images of the face from different angles, the real size of each part of the consumer's face can be obtained. The size of each part of the eyeglass frame is calculated according to the true size of each part of the face according to the foregoing formulas.

In addition to providing a plurality of face capture lenses 112 in front of the display device 12, in another embodiment, the consumer can also capture his/her own face images using a camera lens of the mobile device M itself, e.g., using a front lens of a smart phone at different angles. For example, face images are captured in front of the face and on both lateral sides and the front side at 30 degrees and 60 degrees, respectively, and the captured images are transmitted to the facial feature measurement module 228 of the second servo device 22 via the network N, as described above. The images captured by the mobile device M are composited into a three-dimensional image by the facial feature measurement module 228, and the preferred eyeglass glass size is calculated by the data analysis module 229 according to the foregoing formulas.

In addition, the data analysis module 229 analyzes the facial expression of the consumer for the image obtained by the facial feature measurement module 228. When the consumer views the picture of the try-on eyeglass frame displayed by the display device 12, the consumer's likes and dislikes of the try-on result will be expressed on the face, and therefore, the face capture lens 112 will continue to capture the face images of the consumer, and the face images are composited into a three-dimensional image by the facial feature measurement module 228, and then analyzed by the data analysis module 229 to determine the expression of the consumer, such as smile, satisfaction, strangeness or disappointment. In addition, the data analysis module 229 also analyzes the eyeglass frame stored in the eyeglass frame matching storage module 227 and selected by a plurality of consumers and uses the analyzed result as an empirical value of the recommended eyeglass frame.

In addition, the data analysis module 229 can also determine the age and gender of the consumer according to the face image and can even determine which ethnic group the consumer belongs to according to the clothing in the image, such as office workers or students, or determine consumption habits according to clothing or accessories, such as pursuing fashion or practicality. Data obtained after each determination is stored, various empirical values can be obtained from the big data analysis, and the data analysis module 229 can learn to increase the accuracy of the determination. Therefore, the data analysis module 229 can be an artificial intelligence system. When a consumer's face image appears, the data analysis module 229 can analyze the face image, and facial feature values of the face image, such as the nose bridge height, the nose bridge width, and the eye to ear distance, or the age range, or consumption habits can be obtained for various image features. After the feature values are comprehensively determined, and big data learning according to massive data is made, the most accurate judgment can be directly made, and one or more eyeglass frames suitable for the consumer are recommended.

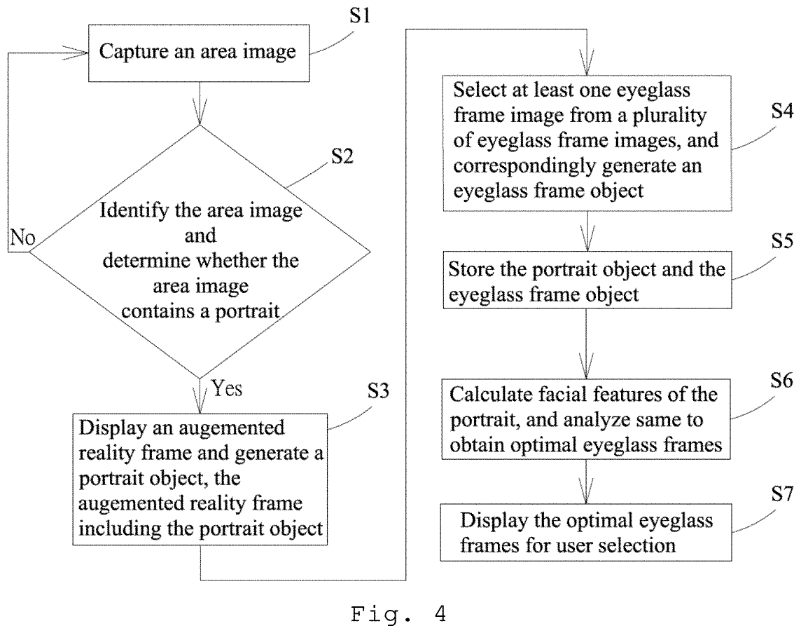

Referring to FIG. 4, an embodiment of an interactive try-on method for eyeglass frame of the present invention is illustrated.

In step S1, an area image is captured. For example, as shown in FIG. 1, an image of the area in front of the display device 12 is captured by the image capture lens 111 of the image capture device 11. Then, the method proceeds to step S2.

In step S2, the image of the area is identified and it is determined whether the image of the area contains a portrait. For example, as shown in FIG. 1, the image of the area is transmitted to the image identification module 211 of the first server 21 for identification. According to the identification result, if the image of the area does not contain a portrait, the method returns to step S1, and if the image of the area contains a portrait, the method proceeds to step S3.

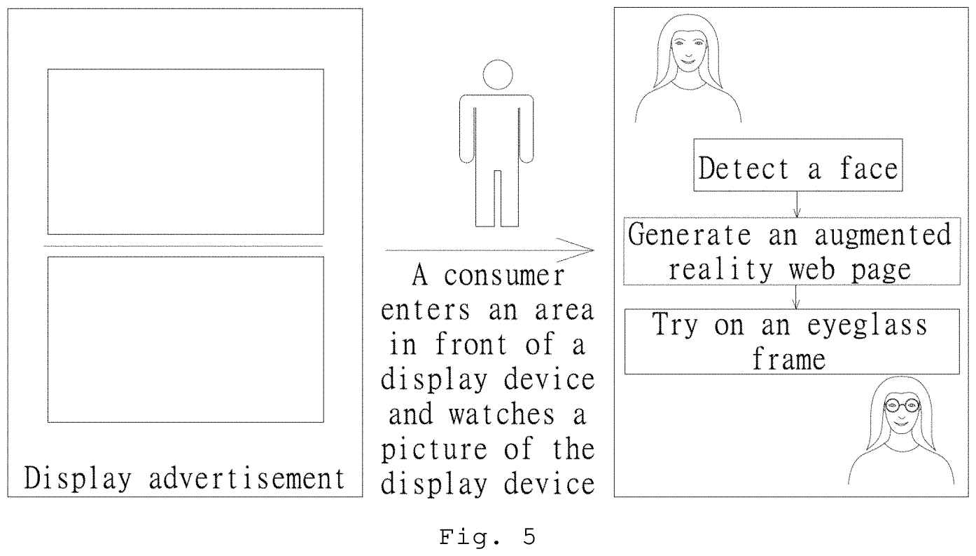

In step S3, an augmented reality frame is displayed and an image object is generated. The augmented reality frame includes the image object. For example, as shown in FIG. 1, augmented reality webpage data is generated by the augmented reality generation module 212 of the first servo device 21, and an augmented reality webpage is displayed in the form of an i-frame, and the consumer's image is integrated into the augmented reality webpage. Referring to FIG. 5, if the area image captured by the image capture lens 111 contains a portrait, the picture of the display device 12 is switched from the picture shown in FIG. 2 to the picture shown in FIG. 3, and a frame W3 for the picture is generated by the augmented reality generation module 212, and a frame W4 for eyeglass frame selection is generated by the eyeglass frame selection module 223. Then, the method proceeds to step S4.

In step S4, at least one eyeglass frame image is selected from the plurality of eyeglass frame images, and an eyeglass frame object is correspondingly generated. For example, eyeglass frame webpage data is generated by the eyeglass frame selection module 223 of the second servo device 22, and the eyeglass frame webpage data includes a plurality of eyeglass frame images and is displayed in the frame W4 of the picture of the display device 12 in FIG. 3. The consumer can select one of the eyeglass frames, and the selected eyeglass frame image is integrated into the augmented reality webpage by the augmented reality generation module 212 and is superimposed on the image to produce a try-on effect.

Then, the method proceeds to step S5.

In step S5, the image object and the eyeglass frame object are stored. When the consumer is satisfied with the try-on result, the eyeglass frame code and the consumer's image can be stored in the eyeglass frame matching storage module 227, and then the method proceeds to step S6.

In step S6, the facial feature of the image in the captured area image is calculated, and the eyeglass frame that is most suitable for the consumer is calculated according to the correlation formulas of the eyeglass frame size and the facial feature size disclosed in the Taiwan Patent Application No. 106118167, which is proposed by the inventor of the present invention. Then, the method proceeds to step S7.

In step S7, the eyeglass frame that is optimal for the consumer is displayed in the display device 12, i.e. the most suitable one for the consumer. For example, the image of the eyeglass frame that is most suitable for the consumer is directly displayed, and the eyeglass frame that is most suitable for the consumer is indicated by text display.

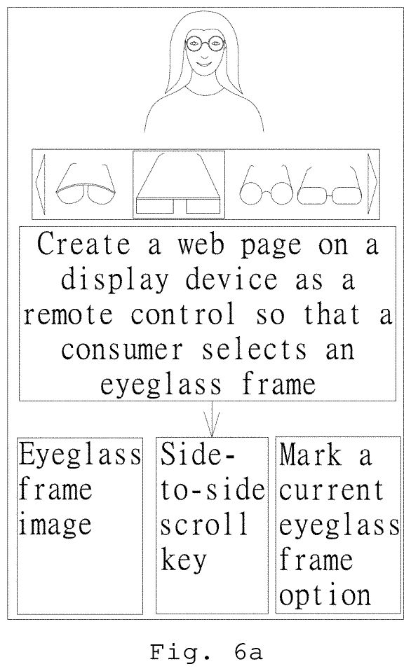

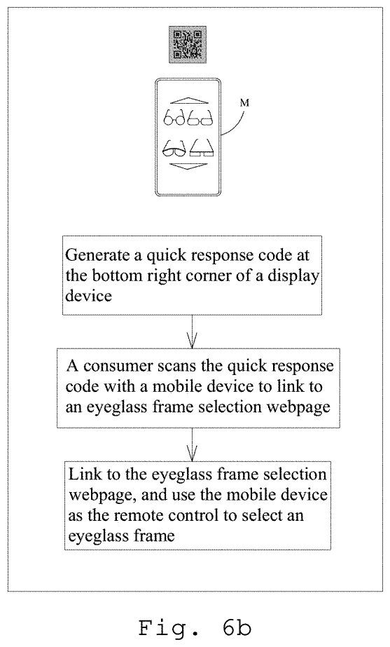

In step S4, at least one eyeglass frame image is selected from the plurality of eyeglass frame images. Referring to FIGS. 6a and 6b for the selection mode, and the selection of the eyeglass frame can be performed by the display device 12 or by the mobile device M. As shown in FIG. 6a, the eyeglass frame selection module 223 generates an eyeglass frame selection webpage, and the eyeglass frame selection webpage is displayed on the display device 12 when the display device 12 is a touch display. The eyeglass frame selection webpage may include eyeglass frame images arranged in a column, a row or an array. An image scrolling up and down or side to side can be set on the eyeglass frame selection webpage. The consumer can scroll the eyeglass frame image side to side or up and down by operating the image scrolling up and down or side to side, and the current eyeglass frame image to be selected is clearly marked by the eyeglass frame selection webpage, for example, by enlarging the current eyeglass frame image to be selected or adding a frame, etc.

The consumer can also use own mobile device M as a remote control for selecting an eyeglass frame. FIG. 6b shows a process for selecting an eyeglass frame by using the mobile device M. The QR code is displayed on the picture displayed by the display device 12, and the consumer can use his/her own mobile device M to scan the QR code on the picture so as to connect to the eyeglass frame selection webpage, and the consumer can select the desired eyeglass frame on the mobile device M.

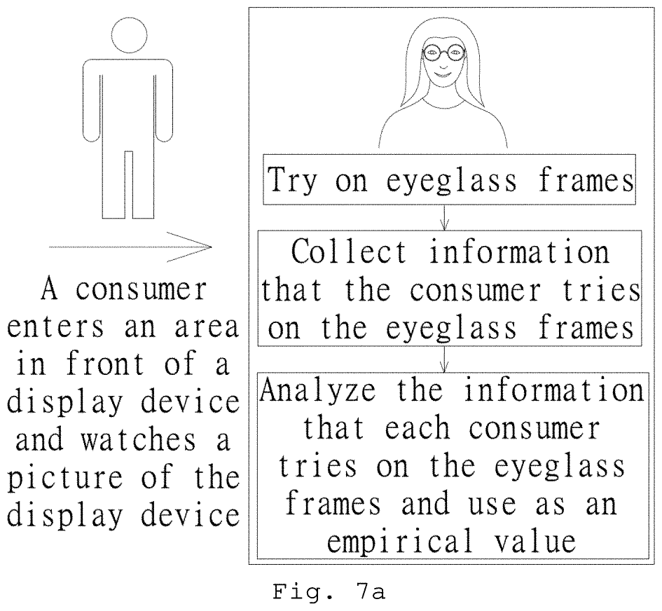

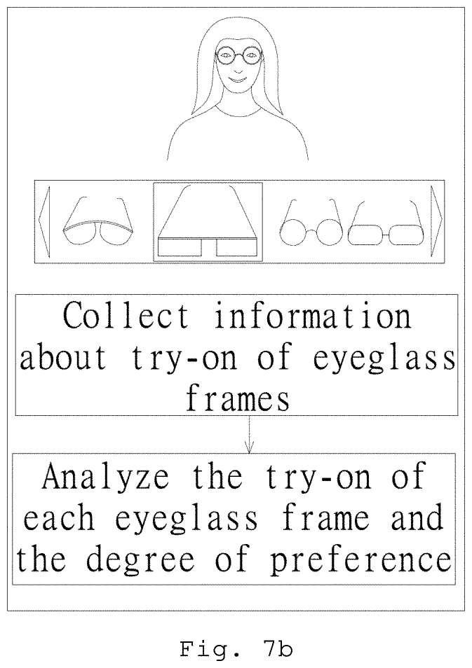

In addition, as shown in FIG. 7a, when the consumer performs simulation of try-on for the eyeglass frame, the information of the consumer trying on the eyeglasses can be collected. For example, the consumers of certain facial forms are preferred on which types of eyeglass frames. The facial features can be obtained by calculating and analyzing the portrait, and then with the shape of the eyeglass frame selected by the consumer, etc., the better combination of the facial form and the eyeglass frame can be analyzed. When a consumer having the facial form appears, the system can directly recommend the eyeglass frame paired with the facial form for the consumer. The interactive try-on system for eyeglass frame of the present invention can collect a large amount of try-on information after a plurality of consumers use the interactive try-on system for eyeglass frame of the present invention and obtain various matching modes of the consumers and the eyeglass frames from the try-on information, and learning and prediction can be made. For some consumers who have little or no contact with the system, the interactive try-on system for eyeglass frame of the present invention can also make a more accurate judgment and recommend a more appropriate eyeglass frame according to the empirical value learned by the large amount of try-on information.

As shown in FIG. 7b, the interactive try-on system for eyeglass frame of the present invention can also analyze the selection information for the eyeglass frames and analyze the number of times the eyeglass frames are selected for try-on, to obtain information about the degree of preference of the eyeglass frames for the consumers.

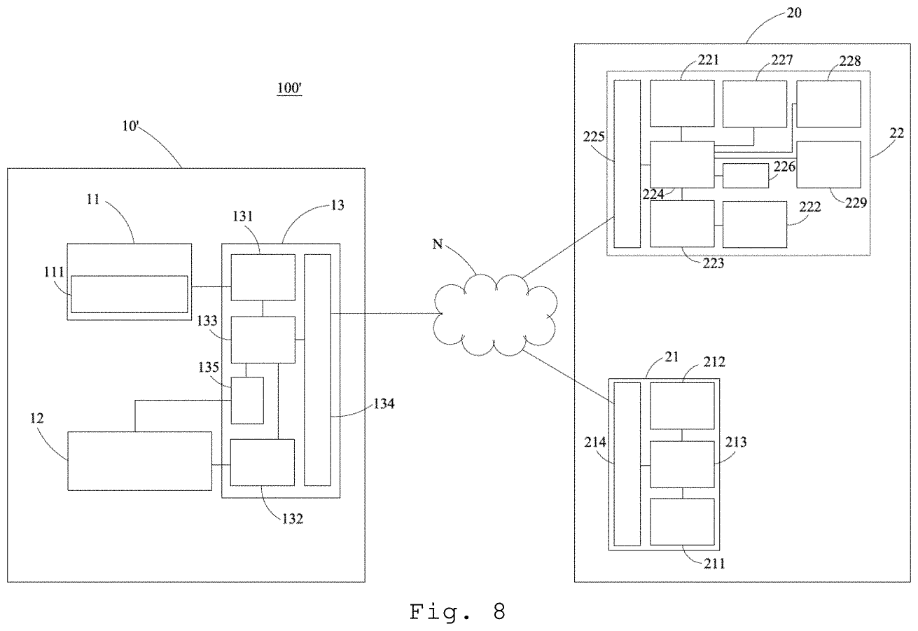

Referring to FIG. 8, another embodiment of an interactive try-on system for eyeglass frame of the present invention is illustrated. The structure of the interactive try-on system 100′ for eyeglass frame of this embodiment is substantially the same as that of the embodiment shown in FIG. 1. Therefore, the same element is denoted by the same reference numeral, and the description thereof will be omitted. In this embodiment, the image interaction unit 10′ is a mobile device, such as a smart phone or a tablet computer. The host device 13 is a mainboard of the mobile device, the display device 12 is a screen of the mobile device, and the image capture device 11 only has the image capture lens 111 which is taken as a photographic lens of the mobile device.

The user can install a try-on application for eyeglass frames in the mobile device. When the user wants to try on the eyeglass frame, the image of the user is directly captured by the photographic lens of the mobile device after the try-on application for eyeglass frames is enabled, and the captured image is transmitted to the image receiving storage module 131, and then transmitted to the augmented reality generation module 212 of the first servo device 21 via the network N. The augmented reality webpage data is generated by the augmented reality generation module 212, and then transmitted to the webpage display module 132 of the image interaction unit 10 (the mobile device) and displayed on the display device 12 (the screen of the mobile device). If the screen of the mobile device is a touch screen, the user can use the touch module 135 to operate the image displayed by the display device 12 to select different eyeglass frames to match with the image, so as to try on the eyeglass frame. In addition, since the mobile device has only one lens, if three-dimensional data of the image is desired, the try-on application for eyeglass frames can also guide a user to photograph images at different angles, so as to composite a three-dimensional head portrait. For example, a picture for guiding photographing appears in the application, the user is respectively guided to photograph the front side, the 45-degree left side, the left side, the 45-degree right side, and the right side of the image, and then the photographed images are transmitted to the facial feature measurement module 228 of the second servo device 22 to measure the size of each feature of the user's face, and then the sizes are analyzed by the data analysis module 229 to obtain an eyeglass frame that is most suitable for the user.

In addition to directly installing a try-on application for eyeglass frames on the mobile device, in another embodiment, the try-on application for eyeglass frames can also be embedded in software, e.g., embedded in a social platform such as Facebook. The try-on application for eyeglass frames can be enabled in a webpage of the social platform when the user browses the webpage, and then the application captures the image of the user according to the foregoing manner and selects the eyeglass frame or generates three-dimensional image data for analysis, and then recommends the most suitable eyeglass frame for the user.

However, the above are only preferred embodiments of the present invention, and do not intended to limit the scope of the present invention.

That is, any simple equivalent change and modification made according to the scopes of the claims and the description of the present invention still fall within the scope of the present invention.

What is claimed is:

1. An interactive try-on system for eyeglass frame, comprising:
an image interaction unit, comprising:
an image capture device comprising at least one image capture lens, the at least one image capture lens facing towards a specific area and configured to capture an image of the specific area and generate an image signal;
a display device configured to simultaneously display a plurality of frames in a picture; and
a host device in signal connection to the image capture device and the display device, comprising an image receiving storage module and a webpage display module, wherein the image receiving storage module is in signal connection to the image capture device and is configured to receive the image signal and store same to form image data; and the webpage display module is in signal connection to the display device and is configured to transmit at least one piece of webpage data to the display device for display; and
a servo unit in signal connection to the image interaction unit, comprising:
a first servo device in signal connection to the host device, comprising an image identification module and an augmented reality generation module, wherein the image identification module is in signal connection to the image receiving storage module and is configured to receive the image data and identify same, and if the image data is identified to contain a portrait, then correspondingly generate a portrait object; and the augmented reality generation module is in signal connection to the image identification module and is configured to receive the image object and generate augmented reality webpage data being transmitted to the webpage display module of the host device; and
a second servo device in signal connection to the host device and the first servo device, comprising a display interface switching module, an eyeglass frame database module, and an eyeglass frame selection module, wherein the display interface switching module is in signal connection to the host device and the first servo device and is configured to switch between a standby interface and a try-on interface according to an identification result of the image data; the eyeglass frame database module is in signal connection to the first servo device and is configured to store a plurality of eyeglass frame codes; and the eyeglass frame selection module is in signal connection to the eyeglass frame database module and is configured to receive a selection signal and select an eyeglass frame code from the eyeglass frame database module according to the selection signal;
wherein the first servo device transmits a control signal to the second servo device when the image identification module of the first servo device generates the portrait object, so that the display interface switching module switches from the standby interface to the try-on interface; the first servo device obtains the eyeglass frame code selected by the eyeglass frame selection module of the second servo device; and the augmented reality generation module generates a corresponding eyeglass frame object according to the eyeglass frame code and adds the eyeglass frame object to the augmented reality webpage data, and superimposes the eyeglass frame object on the portrait object.

2. The interactive try-on system for eyeglass frame according to claim 1, wherein the image interaction unit further comprises a selection device in signal connection to the eyeglass frame selection module of the second servo device and configured to generate the selection signal and transmit the selection signal to the eyeglass frame selection module.

3. The interactive try-on system for eyeglass frame according to claim 1, wherein the image interaction unit is a mobile device comprising a mainboard, a screen, and a photographic lens; the host device is the mainboard; the display device is the screen; and the image capture device is the photographic lens.

4. The interactive try-on system for eyeglass frame according to claim 2, wherein the display device is a touch display, and the selection device is a touch assembly; the touch assembly is disposed on the display device; the host device further comprises a touch module in signal connection to the touch module; and the touch module is in signal connection to the eyeglass frame selection module of the second servo device.

5. The interactive try-on system for eyeglass frame according to claim 2, wherein the second servo device further comprises an eyeglass frame matching storage module in signal connection to the eyeglass frame selection module; the selection device transmits a control signal to the second servo device; and the second servo device stores the eyeglass frame code selected by the eyeglass frame selection module and the portrait object in the eyeglass frame matching storage module.

6. The interactive try-on system for eyeglass frame according to claim 5, wherein the second servo device further comprises an advertisement data supply module in signal connection to the webpage display module of the host device and configured to transmit advertisement webpage data to the webpage display module.

7. The interactive try-on system for eyeglass frame according to claim 1, wherein the second servo device further comprises an advertisement data supply module in signal connection to the webpage display module of the host device and configured to transmit advertisement webpage data to the webpage display module.

8. The interactive try-on system for eyeglass frame according to claim 1, wherein the image capture device comprises a plurality of face capture lenses; the face capture lenses are arranged to capture images of a face from different angles to obtain a plurality of pieces of face image data; and the face capture lenses are actuated after the portrait is identified by the image identification module of the first servo device.

9. The interactive try-on system for eyeglass frame according to claim 8, wherein the second servo device comprises a facial feature measurement module in signal connection to the image capture device and configured to receive the face image data and calculate a plurality of facial feature values; and the facial feature values comprise a nose bridge height, a nose bridge width, and a distance between eye and ear.

10. The interactive try-on system for eyeglass frame according to claim 9, wherein the second servo device further comprises a data analysis module in signal connection to the facial feature measurement module and configured to receive and analyze the facial feature values, send a control signal to the eyeglass frame selection module, select an eyeglass frame code from the eyeglass frame database module, and transmit the eyeglass frame code to the augmented reality generation module; and the augmented reality generation module adds an eyeglass frame object corresponding to the eyeglass frame code to the augmented reality webpage data.

11. An interactive try-on method for eyeglass frame, comprising:
capturing an area image;
identifying the area image;
if it is identified that the area image contains a portrait, displaying an augmented reality frame and generating a portrait object, wherein the augmented reality frame comprises the portrait object;
selecting at least one eyeglass frame image from a plurality of eyeglass frame images, and correspondingly generating an eyeglass frame object;
adding the eyeglass frame object to the augmented reality frame and superimposing the eyeglass frame object to the portrait object;
storing the portrait object and the eyeglass frame object;
calculating facial features of the portrait object and analyzing same to obtain an optimal eyeglass frame; and
displaying the optimal eyeglass frame.
